(19) United States
(12) Patent Application Publication
(10) Pub. No.: US 2002/0101111 A1
(43) Pub. Date: Aug. 1, 2002

(54) Device for sound-proofing a wheel, and especially a motor-vehicle wheel

(75) Inventors: Guy Marron, Gardanne (FR); Jean-Paul Delessert, Vitrolles (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SOLLAC, PUTEAUX (FR)

(21) Appl. No.: 10/029,880

(22) Filed: Dec. 31, 2001

Related U.S. Application Data
(63) Continuation of application No. 08/611,133, filed on Mar. 5, 1996.

(30) Foreign Application Priority Data
Mar. 6, 1995 (FR) 95 02 531

(51) Int. Cl. B60B 19/00

(52) U.S. Cl. 301/6.91

(57) ABSTRACT

The present invention relates to a device for sound-proofing a wheel, and especially a motor-vehicle wheel (1), which wheel comprises a circular central body (2), a substantially cylindrical rim (3) composed of a rear part (4) and a front part (5), the parts being separated by the plane of the body (2) which extends substantially perpendicularly to the longitudinal axis (6) of the rim, wherein it is composed of at least one panel, associated with the rim (3) and placed parallel to the wheel body (2), said panel including at least one layer of a viscoelastic material and a radial mechanical coupling means arranged at the periphery of the panel in order to be associated with at least one of the cylindrical parts (4, 5) of the rim (3).

### FIELD OF THE INVENTION

The present invention relates to a device for sound-proofing a wheel, and especially a motor-vehicle wheel, which wheel comprises a circular central body, a substantially cylindrical rim composed of a rear part and a front part, the parts being separated by the plane of the body which extends substantially perpendicularly to the longitudinal axis of the rim.

### PRIOR ART

To improve the comfort of motor-vehicle users, motor-vehicle constructors are obliged to look for the sources of vibrations in said vehicles and to try to reduce them or, if possible, to eliminate them.

In the field of motor-vehicle wheels, the wheels, produced for example by pressing, flow turning or rolling, have the drawback of emitting vibrations which are felt within the passenger compartment.

The wheel vibrations generate noise which can be of an aerodynamic type, with frequencies above 500 Hz, or of a solid-borne or structure-borne type with frequencies below 500 Hz.

Much research has been carried out on quantifying various effects, especially the influence of the design of the tire tread, the road pavement, the vehicle speed and the steel of which the wheel is composed.

From FR No. 7615476 is known a device for reducing the noise from a wheel when braking, which comprises an elastic plate of the spring-leaf type, the bearing points of which are placed at the vibration antinodes of the wheel.

### SUMMARY OF THE INVENTION

The aim of the invention is to improve the acoustic comfort of motor-vehicle users in every field of operation of the vehicle.

The subject-matter of the invention is a device that is composed of at least one panel, associated with the rim and placed parallel to the wheel body, said panel including at least one layer of a viscoelastic material and a radial mechanical coupling means arranged at the periphery of the panel in order to be associated with at least one of the cylindrical parts formed by the rim.

The other characteristics of the invention are:

the panel is a disk associated with the front cylindrical part of the rim;

the panel is a ring associated with the rear cylindrical part of the rim;

the panel is metallic and preferably made of steel;

the panel is composed of a sandwich-type metal sheet;

the panel forms an embellisher for the wheel;

the panel includes, at the periphery, a mechanical coupling means for putting the panel into radial tension or compression;

the tensioning means is an annular elastic element fitting elastically in a well provided in one of the cylindrical parts formed by the rim;

the means for tensioning the panel is composed of a series of tabs made of spring steel, these being arranged radially at the periphery of said panel and intended to be hooked over a circular border provided on one of the cylindrical parts formed by the rim;

the panel includes at least one relief arranged so as to face a region of high-amplitude vibration of the wheel, this relief being intended to bear against a relief on the wheel body;

the relief has either the shape of at least one groove, taking the form of at least one portion of a circle, or the shape of studs distributed angularly over the surface of the disk.

The description which follows and the appended figures, all given by way of non-limiting example, will make the invention clearly understood.

### DESCRIPTION OF THE DRAWINGS

FIG. 1 illustrates an embodiment of a device according to the invention associated with a wheel.

FIG. 2 illustrates another embodiment of a device according to the invention.

FIG. 3 illustrates an embodiment of a panel according to the invention in the form of a disk.

FIG. 4 is a diagram of a rig for measuring impulse response.

FIGS. 5A and 5B are impulse response curves, respectively in vertical modes and in lateral modes, of a wheel without the device of the invention.

FIGS. 6A and 6B are impulse response curves, respectively in lateral modes and in vertical modes, of a wheel with the device of the invention, this being composed of a panel in the form of a disk as shown in FIG. 3.

FIGS. 7A and 7B are impulse response curves, respectively in lateral modes and in vertical modes, of a wheel with the device of the invention, this being composed of a panel in the form of a disk and of a panel in the form of an associated ring.

FIG. 8 illustrates another embodiment of the invention, this figure showing a coupling means formed by an annular element.

### DESCRIPTION OF THE PREFERRED EMBODIMENTS

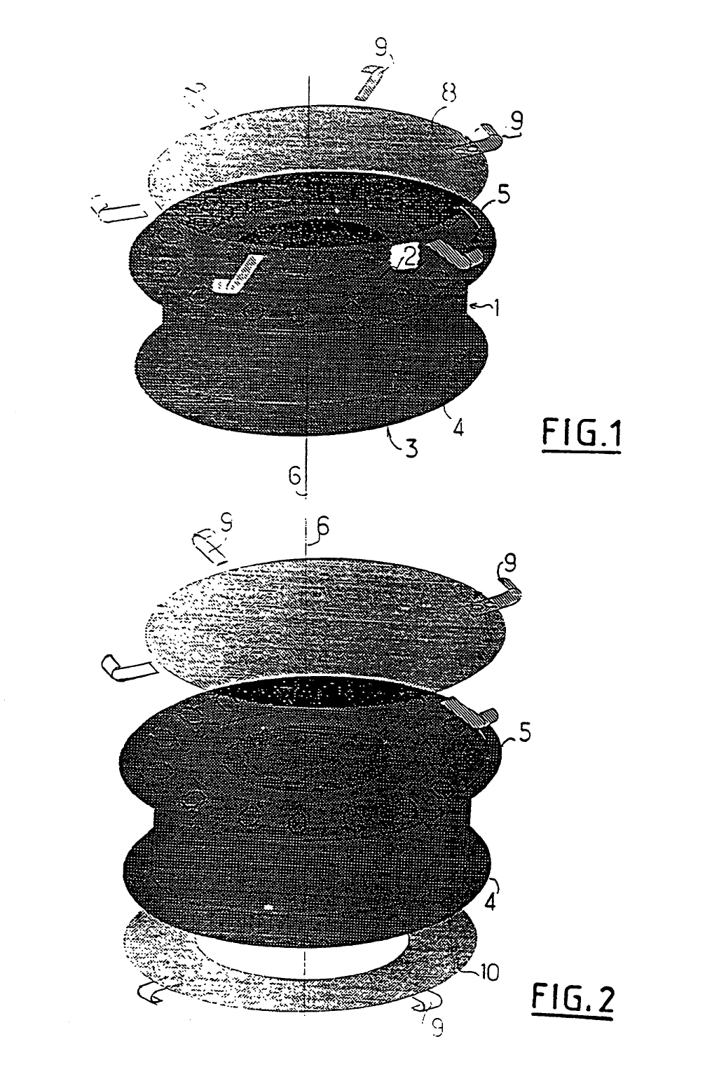

The device for sound-proofing a wheel, for example a motor-vehicle wheel, fits onto a vehicle wheel 1, as shown in FIG. 1, the wheel comprising a circular central body 2, a substantially cylindrical rim 3 composed of a rear part 4 and a front part 5, the parts 4 and 5 being separated by the plane of the body 2 which extends perpendicularly to the longitudinal axis 6 of the rim 3, this axis corresponding to the axis of rotation of the wheel.

According to the invention, the device for sound- proofing the wheel is composed of a panel preferably made from a metal sheet, it being possible for the panel to be obtained by pressing and to have the shape of a disk 8, like the shape of a dinner plate for example, or the shape of a ring 10.

The panel includes at least one layer of viscoelastic material, which material has the property of absorbing the energy due to mechanical vibrations and this energy being converted into heat within the material. The layer of viscoelastic material can be inserted between two metal disks in order to form a sandwich structure.

The panel of the device includes means of mechanical coupling to the rim 3 of the wheel. These coupling means put the panel into radial compression or into radial tension so that the wheel vibrations can be transmitted to the viscoelastic material of the panel of the device in order to obtain the energy absorption effect.

A mechanical coupling means is, for example, an annular elastic element which fits elastically in a well provided in a cylindrical part formed by the rim.

The annular element is, for example, a rolled edge 16 at the periphery of the panel.

Another mechanical coupling means is, for example, as shown in FIGS. 1 and 2, composed of a series of tabs 9 made of spring steel, these being arranged radially at the periphery of the panel of the device, the tabs 9 being intended to be hooked over a circular border provided on one of the cylindrical parts 4, 5 formed by the rim 3.

According to the invention, the panel in the form of a disk 8 of the device is placed on the wheel so as to cover the means for fixing the wheel to the wheel shaft. The disk 8 can therefore have an attractive shape and act as an embellisher.

According to the invention, and as shown in FIG. 2, the device may include two panels forming, on the one hand, a disk 8 placed on the front part 5 of the rim and, on the other hand, a ring 10 placed on the rear part 4 of the rim.

Measurements have been taken in order to demonstrate the effect of absorbing the vibratory energy communicated to a motor-vehicle wheel.

These measurements were taken with a device which includes a compressed mechanical coupling means, as shown in FIGS. 1 and 2.

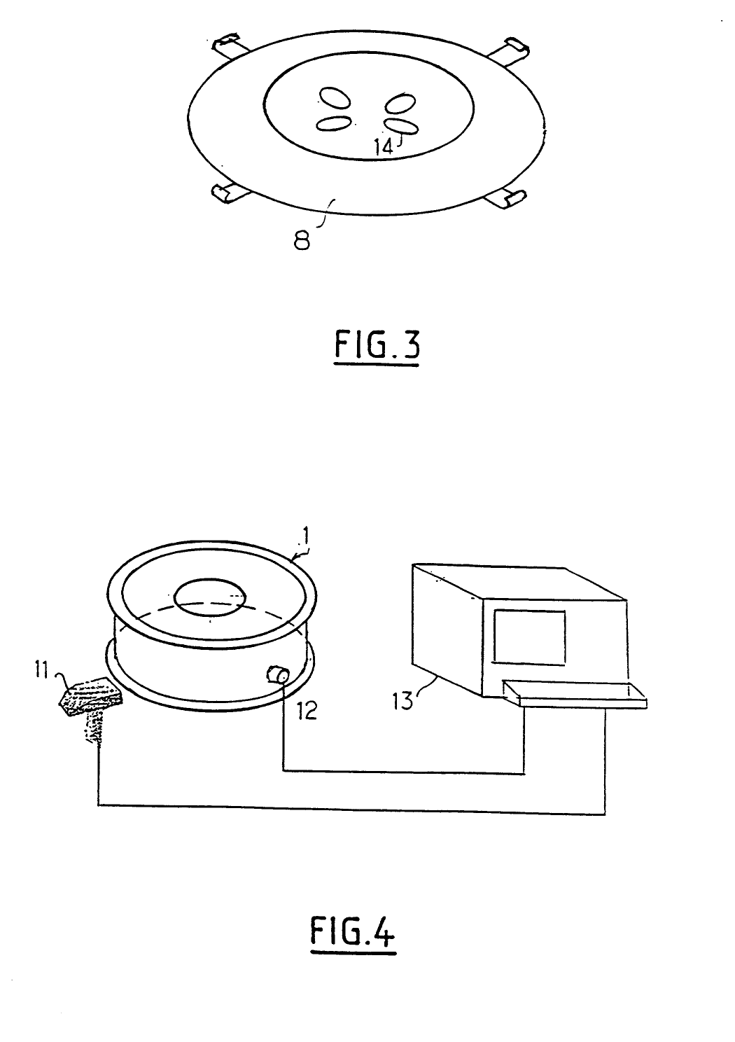

A motor-vehicle wheel 1 is subjected to vibrations so as to reveal the vibrational modes of the wheel, on the one hand, without the device of the invention and, on the other hand, with said device of the invention, this comprising a panel in the form of a disk 8, as shown in FIG. 3.

An experimental rig for measuring the resonant frequency and the noise level is illustrated diagrammatically in FIG. 4. The measurement rig includes an impact hammer 11, an accelerometer 12, a force sensor and a two-channel spectrum analyzer 13. This rig makes it possible to determine impulse response curves of the wheel 1 subjected to vibrations.

The device associated with the wheel is composed of a panel in the form of a disk 8 pressed from a sandwich metal sheet of the “GROUND COMFORT” type having a thickness of 0.75 mm. The disk-shaped panel of the device is pierced, for example by four holes 14 provided in its central part. The panel forms a curved member which bears on the cylindrical front part 5 formed by the rim. The disk 8 is fixed in mechanical compression by means of tabs 9 made of spring steel forming clips which are inserted into an internal well of the front part 5 of the rim.

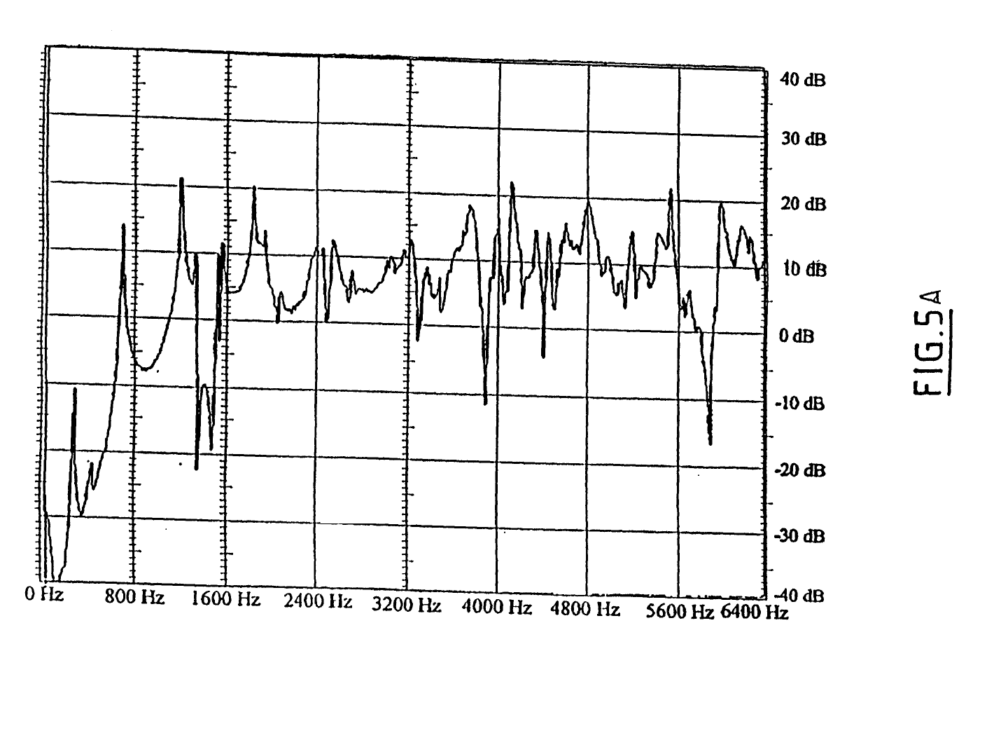

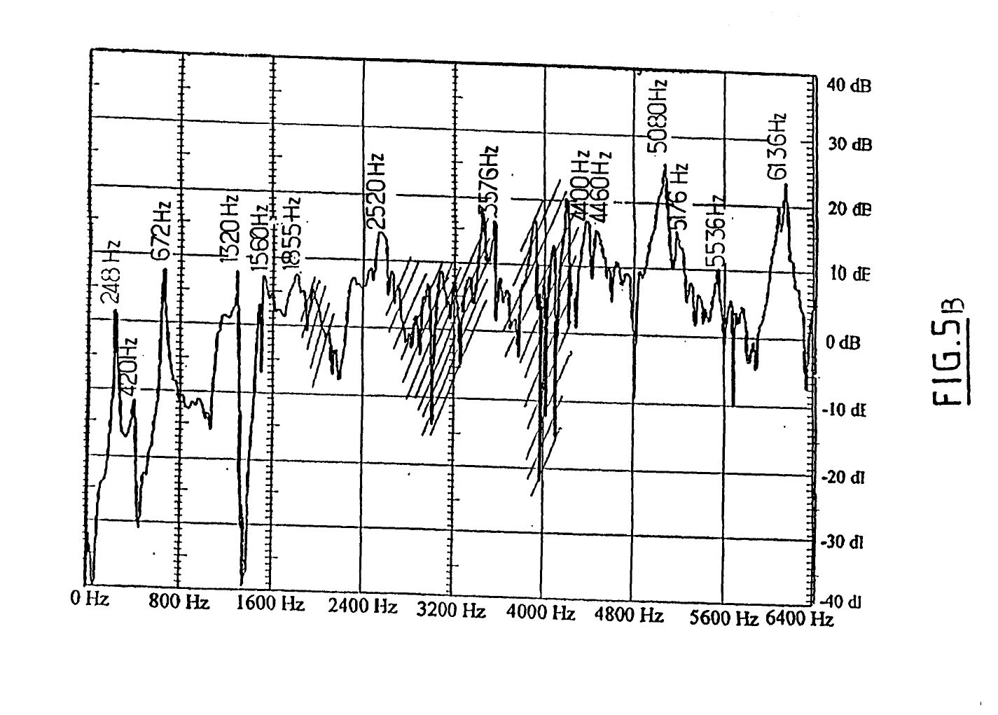

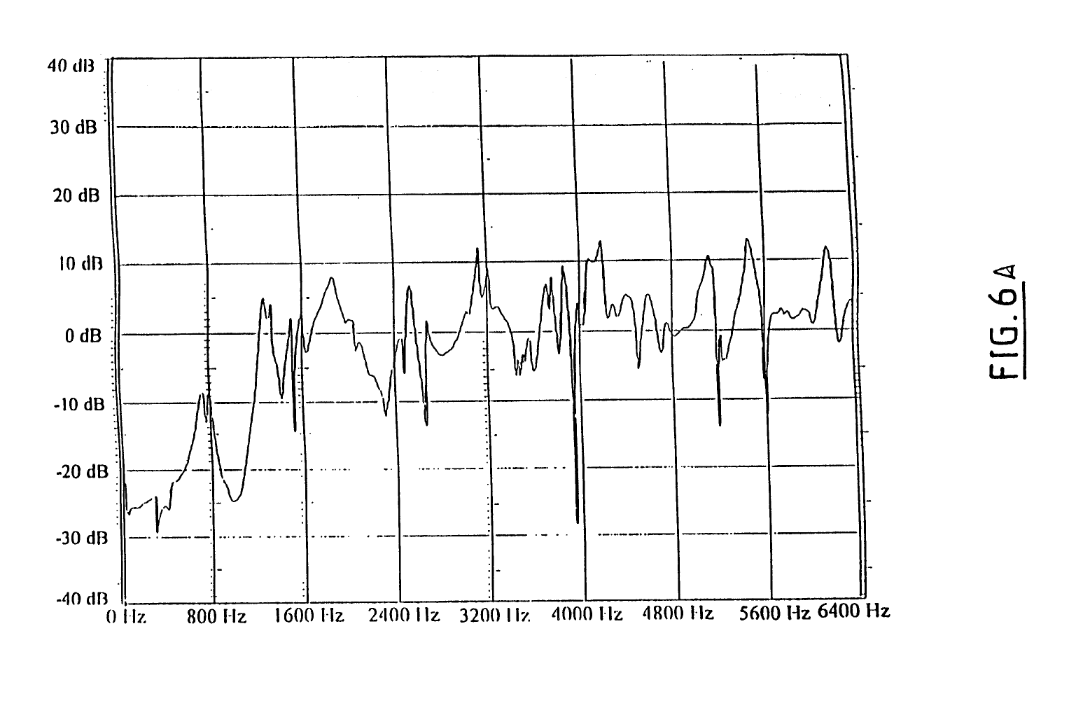

FIGS. 5A and 5B illustrate impulse response curves of the wheel, respectively in vertical modes and in lateral modes, without the device of the invention. These show the following resonant peaks:

| Mode | Frequency (Hz) | Mode | Frequency (Hz) |
|---|---|---|---|
| 1 | 253 | 6 | 719 |
| 2 | 253 | 7 | 719 |
| 3 | 253 | 8 | 1094 |
| 4 | 258 | 9 | 1140 |
| 5 | 498 | 10 | 1140 |

It is in particular the low-frequency vibration modes which it is desired to reduce, or indeed to eliminate. It has been observed that the rim is the most influential component of the wheel, and more particularly the rear and front parts of the rim.

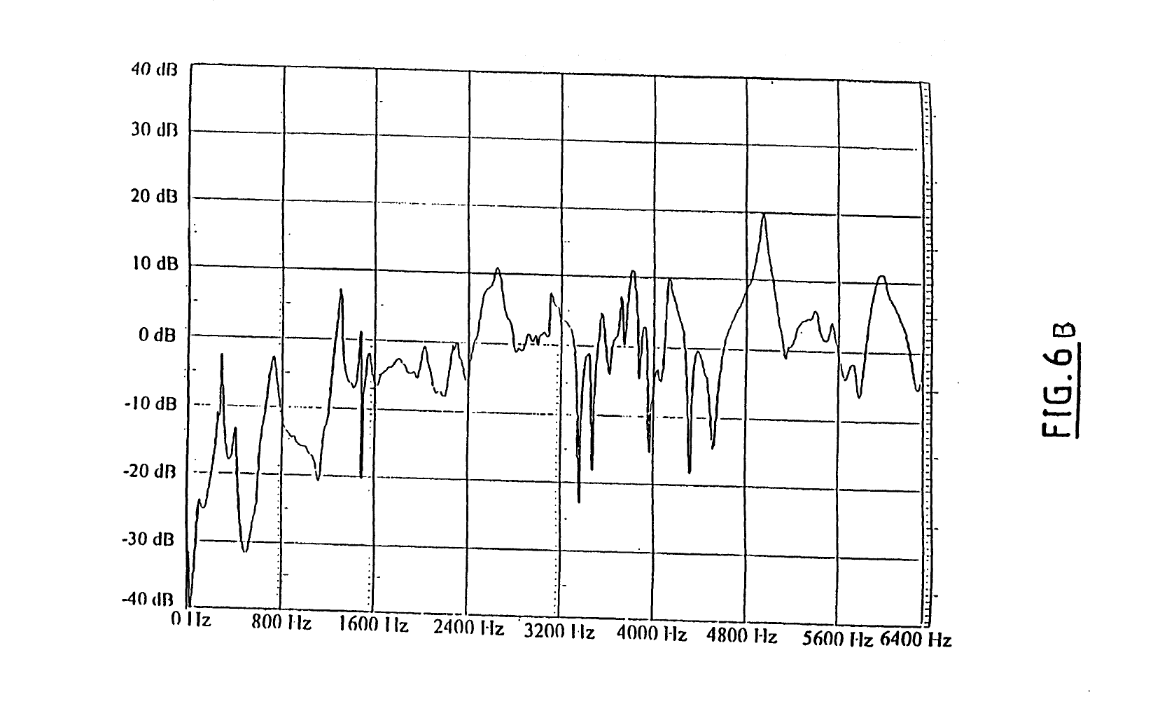

FIGS. 6A and 6B illustrate impulse response curves of the wheel, respectively in vertical modes and in lateral modes, with the device according to the invention, this being composed, in this example, of a panel in the form of a disk 8.

By comparing the two impulse response curves in vertical modes, it may be seen that the 250 Hz resonant peak is attenuated by approximately 15 dB and that the 700 Hz resonant peak is attenuated by approximately 23 dB, which is considerable. There is a tendency for some of the high-frequency resonant peaks to disappear. A slight shift of the peaks toward the higher frequencies is also observed, showing that the device, in radial compression, tends to stiffen the wheel.

Comparing the impulse responses of the wheel, in lateral modes without the device and with the device according to the invention, shows that the 250 Hz resonant peak is attenuated by approximately 7 dB and the 700 Hz one is also attenuated by 15 dB.

It is possible to produce on the panel in the form of a disk 8, as shown in FIG. 8, at least one relief 15 intended, preferably, to bear against a relief on the wheel body 2. The relief is placed so as to face regions of vibration of the body which are subjected to large amplitudes and which represent vibration antinodes. The reliefs shown in FIG. 8 have the shape of studs distributed angularly over the surface of the disk 8. These reliefs may also have the shape of a groove or of any other dished shape providing, on the one hand, a mechanical function and, on the other hand, an esthetic embellisher function.

The relief 15 can also be given a particular shape so as to modify the vibratory behavior of the panel, generating regions of low-amplitude vibrations, generally called vibration nodes. With this shape, the contacting of the relief 15 with a relief on the wheel body 2 is no longer necessary.

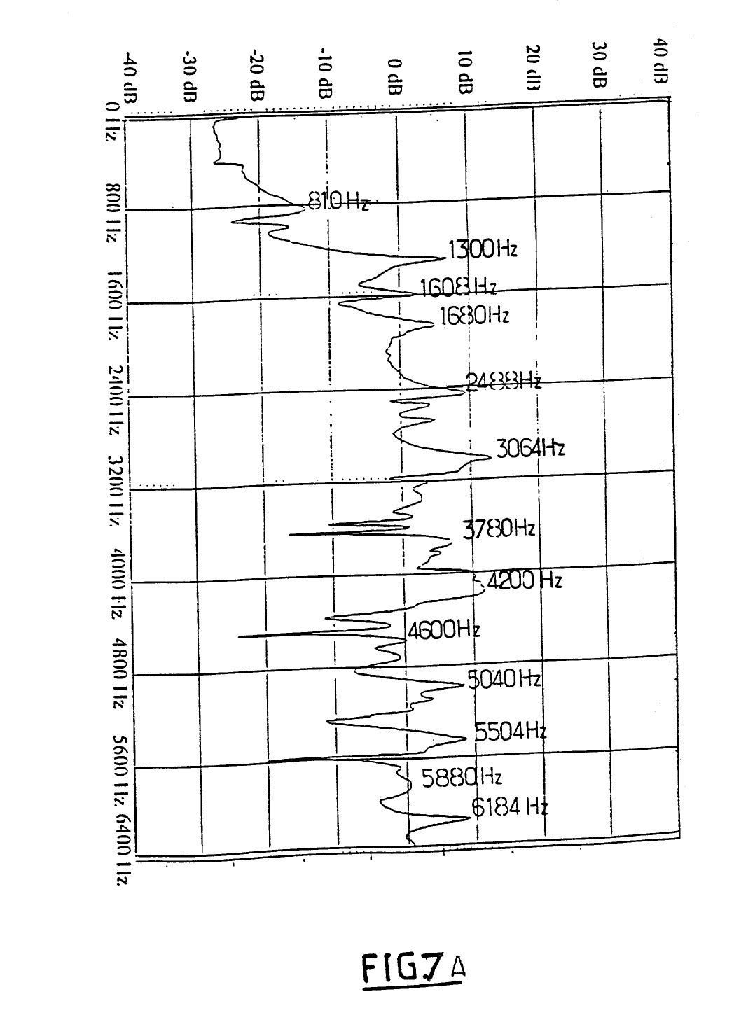

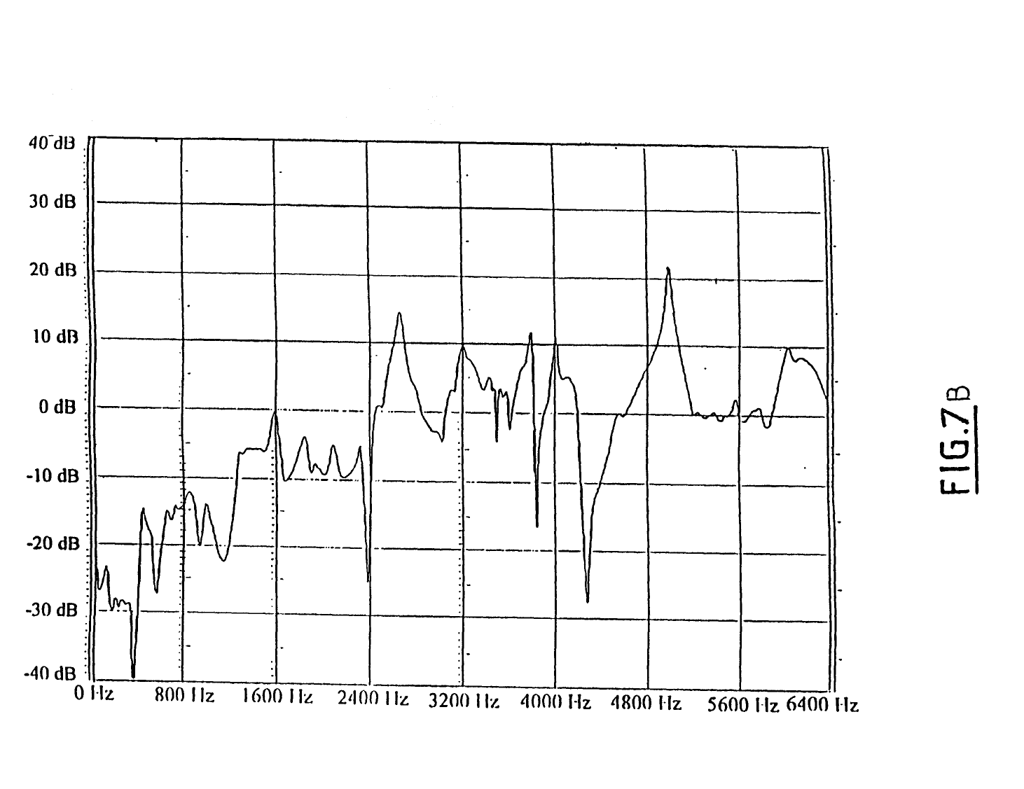

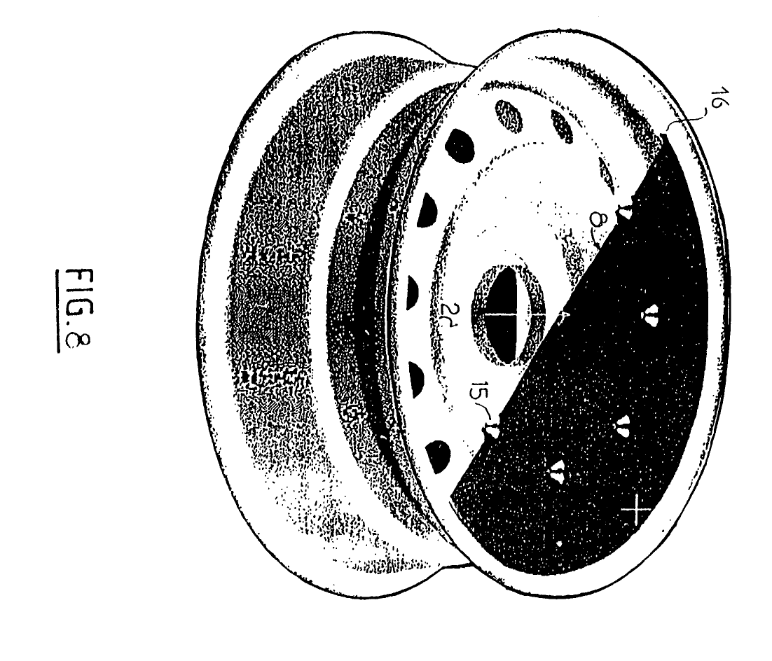

FIGS. 7A and 7B illustrate impulse response curves of the wheel, respectively in vertical modes and in lateral modes, with the device according to the invention, this being composed, in this example, of a panel in the form of a disk 8 placed on the front part 5 of the rim and a panel in the form of a ring 10 placed on the rear part 4 of the rim.

The panel in the form of a ring 10 is circular with an internal diameter of 250 mm and an external diameter of 342 mm. It is fixed to the rear part 4 of the rim by means of tabs 9 allowing a large radial stress. Impact measurements were made using an impact hammer as described previously.

With respect to the lateral modes, the following is observed:

a 25 dB attenuation of the resonant peak appearing at the 250 Hz frequency;

a 10 dB attenuation of the resonant peak appearing at the 700 Hz frequency.

With respect to the vertical modes, the following is observed:

a 5 dB attenuation of the resonant peak appearing at the 250 Hz frequency;

a 5 dB attenuation of the resonant peak appearing at the 700 Hz frequency.

It may be seen that the low-frequency resonant peaks, which are the most annoying for motor-vehicle passengers, have completely disappeared.

A slight shift of the resonant peaks to high frequencies is also observed, which means that the device according to the invention improves the wheel in terms of its stiffness.

What is claimed as new and desired to be secured by Letter Patent of the United States is:

1. A device for sound-proofing a wheel which wheel comprises a circular central body, a substantially cylindrical rim comprising a rear part and a front part, the parts being separated by the plane of the body which extends substantially perpendicularly to the longitudinal axis of the rim, wherein it is comprised of at least one panel, associated with the rim and placed parallel to the wheel body, said panel including at least one layer of a viscoelastic material and a radial mechanical coupling means for putting the panel into radial tension or compression, arranged at the periphery of the panel in order to be associated with at least one of the cylindrical parts of the rim.

2. The device as claimed in claim 1, wherein the panel is a disk associated with the front cylindrical part of the rim.

3. The device as claimed in claim 1, wherein the panel is a ring associated with the rear cylindrical part of the rim.

4. The device as claimed in claim 1, wherein the panel is metallic.

5. The device as claimed in claim 1, wherein the panel is made of steel.

6. The device as claimed in claim 1, wherein the panel is composed of a sandwich-type metal sheet.

7. The device as claimed in claim 1, wherein the panel forms an embellisher for the wheel.

8. The device as claimed in claim 1, wherein the panel includes, at the periphery, a mechanical coupling means for putting the panel into radial tension or compression.

9. The device as claimed in claim 1, wherein the tensioning means is an annular elastic element fitting elastically in a well provided in one of the cylindrical parts formed by the rim.

10. The device as claimed in claim 1, wherein the means for tensioning the panel is composed of a series of tabs made of spring steel, these being arranged radially at the periphery of said panel and intended to be hooked over a circular border provided on one of the cylindrical parts formed by the rim.

11. The device as claimed in claim 1, wherein the panel includes at least one relief arranged so as to face a region of high-amplitude vibration of the wheel, this relief being intended to bear against a relief on the wheel body.

12. The device as claimed in claim 11, wherein the relief has either the shape of at least one groove, taking the form of at least one portion of a circle, or the shape of studs distributed angularly over the surface of the disk.
